(19) United States
(12) Patent Application Publication
(10) Pub. No.: US 2007/0025309 A1
(43) Pub. Date: Feb. 1, 2007

(54) Home agent apparatus and communication system

(75) Inventors: Masashi Yano, Kawasaki (JP); Takehiro Morishige, Hachioji (JP); Katsumi Konishi, Kawasaki (JP)

Correspondence Address: Stanley P. Fisher;Reed Smith LLP, Suite 1400, 3110 Fairview Park Drive, Falls Church, VA, 22042-4503, US

(73) Assignee: Hitachi Communication Technologies, Ltd.

(21) Appl. No.: 11/328,144

(22) Filed: Jan. 10, 2006

(30) Foreign Application Priority Data
Jul. 27, 2005 (JP) 2005-216643

(51) Int. Cl. H04Q 7/24

(52) U.S. Cl. 370/338

(57) ABSTRACT

If security cannot be ensured between a mobile node and a corresponding node for the communication utilizing Mobile IPv6, communication is exposed to a threat such as tapping of communication content at the moving destination when the mobile node makes the route-optimized communication. In the case where the route-optimized communication is conducted for a communication partner as the communication using the. Mobile IPv6, the mobile node has the automatic setting function to use the IPsec and also has the function to use the tunnel protected by the IPsec between the mobile node and the home agent apparatus when the setting of the IPsec with the communication partner fails.

### CLAIM OF PRIORITY

The present application claims from Japanese application JP 2005-216643 filed on Jul. 27, 2005, the content of which is hereby incorporated by reference into this application.

### FIELD OF THE INVENTION

The present invention relates to a mobile data communication system and more particularly to the technology for insuring security through encryption of packets when a mobile node makes communication while it is moving among networks.

### BACKGROUND OF THE INVENTION

With spread of small-size and light weight mobile nodes such as notebook type personal computers and PDAs (personal digital assistances) and explosive spread of the Internet, the environment allowing use of terminals at the moving destination areas other than the own houses and business offices is now set in order. Moreover, the access environment to the IP network with the high-speed public wireless system such as the hot spot services utilizing the third generation mobile phone, PHS and wireless LAN, etc. has also been established.

In general, the IP network is formed by mutually connecting a plurality of networks (called sub-networks) of different network addresses and the mobile nodes connected to the sub-networks are given the IP addresses selected from the IP address group which is assigned to each sub-network. Since the packets which are transferred among the sub-networks are generally forwarded on the basis of the network address, the mobile nodes must be given different IP addresses assigned from the IP address group assigned to the sub-network of the moving destination each time when the mobile node moves to the other sub-network.

The IPv6 in which the address space is expanded to 128 bi8ts as the Internet communication protocol of the next generation is now spreading in place of the IPv4 in which the address space of 32 bits is widely used as the Internet communication protocol. For the IPv6, the technology which is called the Mobile IPv6 (RFC3775) has been proposed, in which connections may be continuously maintained even when a mobile node moves to the other sub-network in order to solve the problem explained above. This technology is standardized by the Internet Engineering Task Force (IETF).

In the Mobile IPv6, a mobile node defines a sub-network (home network) to which the relevant mobile node belongs in the sub-network explained above. The mobile node is given the assigned home address as the IP address used in the home network and a home agent apparatus having the function for management of position information of mobile node using the relevant sub-network as the home network is allocated in the home network.

The prefix addresses of IPv6 are assigned to each sub-network. In the sub-network of the moving destination, each mobile node acquires the prefix address of the sub-network in the moving destination from the RA (router advertisement) information advertised by an advertisement router in the moving destination and also acquires the care-of address which is temporarily used in the sub-network in the moving destination through the auto-configuration function of the IPv6 or through assignment of the address with the DHCP (dynamic host configuration protocol). The mobile node notifies the home agent apparatus of the care-of address acquired. Subsequently, the home agent apparatus catches the IPv6 packets arriving at the home address of the mobile node and sends the capsulated IPv6 packets to the care-of address. The mobile node decapsulates the capsulated packets arriving at the care-of address and receives the IPv6 packets arriving at the home address.

In the case explained above, the packets of the mobile node and corresponding node are once sent via the home agent apparatus. Therefore, the communication cannot be implemented passing the optimum communication route. Accordingly, when the mobile node receives the packets from the corresponding node via a tunnel through the home agent apparatus, it performs the RR (return routability) sequence in order to check the corresponding node whether this corresponding node has the function to make direct communication without the home agent apparatus. When the RR sequence has been completed successfully, the mobile node performs the binding update registration for notifying the care-of address used temporarily in the sub-network in the moving destination of the corresponding node like the binding update registration to the home agent apparatus. Thereafter, the corresponding node optimizes the route by sending in direct the packets to the mobile node by making use of the care-of address (refer to the first non-patent document, “C. Perkins, J. Arkko “Mobility Support in IPv6” RFC3775, June 2004).

Next, a problem of security in the Mobile IPv6 will be explained. In the Mobile IPv6, use of the IPsec for authentication and encryption of the IP packets is assumed as essential condition for packet protection of the binding update registration between the mobile node and the home agent apparatus (RFC3776). The reason is that if the binding update registration packets are received from the corresponding node not yet authenticated, the packets may be transferred to the other destination not authenticated in place of the node to which the packets must be transmitted inherently and thereby a problem on security such as pretension and tapping of communication content will be generated (refer to the second non-patent document , “J. Arkko, V. Devarapalli, F. Dupont “Using IPsec to Protect Mobile IPv6 Signaling Between Mobile Nodes and Home Agents” RFC3776, July 2004). The same is also true in the binding update registration to be used for optimization of route between the mobile node and the corresponding node.

Moreover, when the wireless LAN, for example, is used in the network in the moving destination, communication content can be tapped easily in the base station where encryption is not conducted or when management is conducted using the key information of the identical encryption among users of the base station even if the encrypting function of the base station is used. In the network of the moving destination, as explained above, it is assumed that a problem on security exists as a result of comparison with the home network used in general.

In order to solve the problem explained above, it is assumed to apply the IPsec explained above not only to the packets for binding update registration but also to the user packets. The IPsec can be authenticated and encrypted, as is specified by the RFC2401, with the common key used for safe communication between a transmitting node and a receiving node (refer to the third non-patent document, “S. Kent, R. Atkinson, “Security Architecture for the Internet Protocol” RFC2401, November, 1998). Accordingly, it is requested for the transmitting and receiving nodes before start of communication by the IPsec to decide the common key, authentication and encryption algorithms and parameter required for the algorithm, etc. This decision is called security association (SA). Moreover, a security policy database (SPD) indicating the policy for application of packets is stored to the node for the IPsec communication. For the communication with the corresponding node matched with this policy, authentication and encryption are conducted on the basis of the SA information explained above.

The IPsec can also be applied in the IPv6 environment. When communication is conducted via the home agent apparatus not only with the binding update registration packets between the mobile node and the home agent apparatus but also with the packets between the mobile node and corresponding node, security can be maintained by protecting the tunnel to be used for packet transfer between the mobile node and home agent apparatus with the IPsec.

### SUMMARY OF THE INVENTION

Communication using the IPsec can also be made, as explained above, even in the environment of the Mobile Ipv6. It is considered here, however, that the mobile node, which does not usually using the IPsec, moves from the home network and makes communication in the moving destination in the case where the mobile node is existing in the safe home network and the corresponding node also exists in the safe network. In this case, since the mobile node and corresponding node are not yet registered to the security policy database, safe communication with the IPsec cannot be implemented, if setting of the security policy database and security association to realize safe communication in the network in the moving destination is not yet conducted only during the moving. Therefore, when the route optimization is conducted only during the moving, load of user, administrator of server, mobile node and server such as setting of security policy database and security association of the IPsec to the mobile node and corresponding node will increase.

Moreover, if setting of security policy database and security association has been impossible between the mobile node and the corresponding node, when the mobile terminal uses the wireless LAN or the like to which security is not insured in the moving destination, communication is exposed to a threat such as tapping of communication content. In this case, it is recommended to realize communication via the home agent apparatus under the condition that optimization of route is not utilized and packets between the mobile node and the corresponding node utilize uses the tunnel in which security between the home agent apparatus and the mobile node is insured without use of the optimization of route. Accordingly, if security association of the IPsec is not acquired between the mobile node and the corresponding node, the setting must be updated, without use of the optimization of route, to make communication via the home agent and thereby complicated sequence is requested to the users and mobile nodes.

It is therefore an object of the present invention to acquire the security through automatic setting in order to assure safe communication among mobile nodes in the mobile node communication network.

According to one aspect of the present invention, a mobile node and a corresponding node utilized in this invention are assumed to be respectively provided with a means for optimizing the route in the Mobile IPv6.

According to another aspect of the present invention, the mobile node is assumed to be provided with a function to make the encrypted communication by the IPsec with the corresponding node on the basis of the security policy database and security association set to the mobile node.

The mobile node generates a care-of address which is temporarily used in the network in the moving destination from a router advertisement included in the router in the moving destination when the mobile node moves from the home network to which it is usually belongs and registers this care-of address to the home agent apparatus as the binding update registration. Upon reception of the effective binding update registration, the home agent apparatus has the function to hold binding of the home address to the care-of address into the home agent apparatus and catch the packets to the home address of the mobile node and also has the function to transfer the capsulated packets to the care-of address of the mobile node. Moreover, in view of protecting the packets for binding update registration and the packets of user data, the mobile node and the home agent apparatus mutually have the function to statistically set or dynamically generate or set the security policy database and security association to protect the packets used for the binding update registration and the user data packets.

The mobile node also has a function to test whether the corresponding node has the route optimization function to make direct communication by no means of the home agent apparatus or not in the case where the packets from the corresponding node are received in the form of the encapsulated packets to the care-of address via the home agent apparatus in the network in the moving destination. The mobile node has a function to set, when this test is completed successfully, the packets exchanged with the corresponding node to be protected with the IPsec.

According to the other aspect of the present invention, the mobile node can provide protected communication at the moving destination by automatically conducting the setting for realizing route optimized communications when the corresponding node a function to make route optimized communication and communication protected by the IPsec is possible between the mobile node and the corresponding node and by conducting the setting for making communication by utilizing the function to transfer the encapsulated packets between the mobile node and the home agent apparatus when the communication protected by the IPsec is impossible between the mobile node and the corresponding node.

### BRIEF DESCRIPTION OF THE DRAWINGS

FIG. 1 is a network configuration diagram to which the present invention is applied;

FIG. 2 is a sequence diagram when route optimization and IPsec communication can be implemented between MN and CN;

FIG. 3 is a sequence diagram when IKE has failed after success of RR sequence between MN and CN;

FIG. 4 is a flowchart illustrating operation of MN;

FIG. 5 is a sequence diagram when IKE has completed successfully after binding update registration between MN and CN;

FIG. 6 is a sequence diagram when IKE has failed after binding update registration between MN and CN;

FIG. 7 is a flowchart of MN for implementing IKE after binding update registration between MN and CN;

FIG. 8 is a communication route diagram between MN and CN;

FIG. 9 is a sequence diagram for filtering in HA; and

FIG. 10 illustrates an example of configuration of MN, HA, and CN.

### DETAILED DESCRIPTION OF THE PREFERRED EMBODIMENTS

A mobile node is also capable of realizing communications protected with the IPsec without any manipulations of users even in the moving destinations.

### First Embodiment

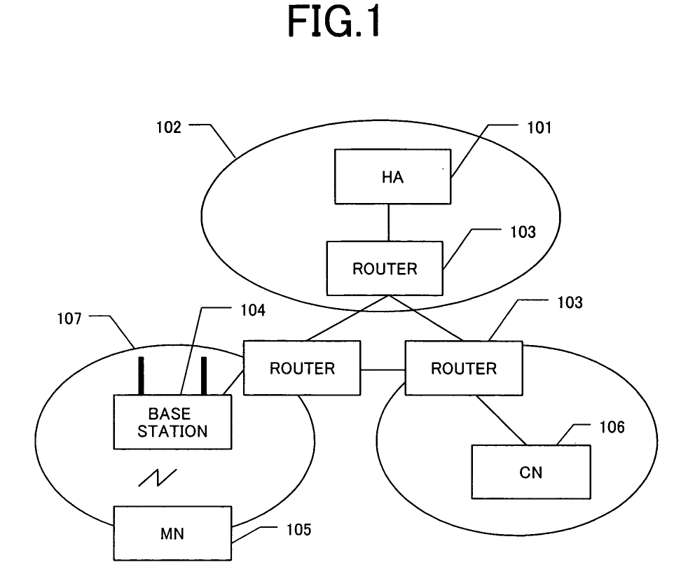

FIG. 1 is a system configuration diagram of a mobile communication system on the basis of the embodiments of the present invention. In FIG. 1, (101) is a home agent apparatus (hereinafter abbreviated as HA) which accepts binding update (BU) registration from a mobile node (hereinafter abbreviated as MN) (105) for the purpose of binding update management of MN. This home agent HA also has a function to encapsulate packets transmitted to the home address of the MN (105) and to transfer the encapsulated packets to a care-of address registered at the time of binding update registration when the MN moves to a sub-network (107) other than the home network (102). (103) is a router for transfer of IP packets. This router advertises information of the sub-network (107) where the mobile node is located to such mobile node existing in the relevant sub-network. (104) is a base station of a wireless LAN or the like in order to accommodate mobile nodes. (105) is an MN having the address belonging to the home network as the fixed address. This MN also has functions to acquire the care-of address based on the information of sub-network advertised with the router (103) in the moving destination using the IPv6 stateless address automatic setting function of IPv6 or DHCPv6 (Dynamic Host Configuration Protocol v6) or the like and to conduct the binding update registration to the HA (101) in the sub-network (107) in the moving destination when the MN is moving. (106) is a terminal or a server as a corresponding node (hereinafter abbreviated as CN) of the MN (105). Accordingly, communication can be implemented with the MN via the HA (101) or direct communication can also implemented with the MN through route optimization.

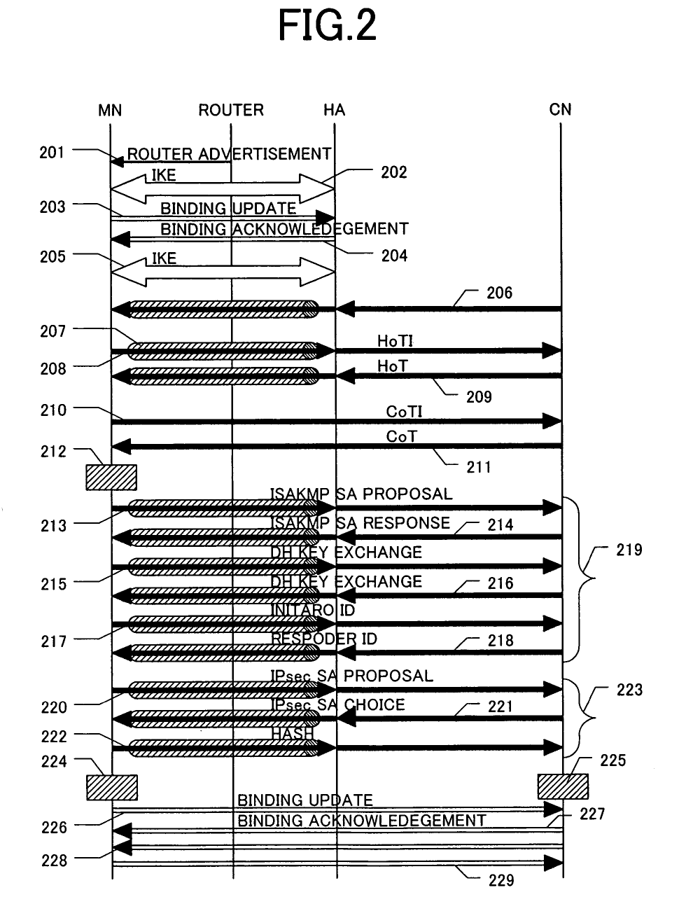

Operations up to the step where the MN (105) realizes safe communication by the IPsec with the CN (106) through optimization of route will be explained with reference to FIG. 2. When the MN (105) moves from the home network (102) to the sub-network (107) in the moving destination, the MN (105) first receives router advertisement (201) advertised by the router (103) within the range of services provided by the base station (104) and generates a care-of address by acquiring the prefix information of the sub-network in the moving destination using the prefix information included in the router advertisement (201). Otherwise, the MN (105) is also capable of acquiring the care-of address from the network in the moving destination using the DHCPv6 (Dynamic Host Configuration Protocol IPv6) or the like. The MN (105) conducts encryption using the common key of the packets between MN and HA or uses the IPsec for message authentication, at the time of conducting the binding update registration to the HA (101), in order to cancel the binding update registration from illegal mobile nodes (MN) and prevent falsification of packets for binding update registration. (202) is operation of IKE (Internet Key Exchange) to generate SA (Security Association) by dynamically exchanging algorithm and key used for encryption or message authentication between the MN and the HA in order to use the IPsec. For generation of the SA, it may be generated dynamically like the (202) or may be generated through previous mutual setting between the MN and the HA. (203) is binding update registration to the HA conducted by the MN. In this case, the MN notifies the care-of address acquired and the home address of the MN of the HA (101). (204) is a response of the HA to the binding update registration (203) indicating that the HA has acknowledged the binding update registration from the MN. (205) is IKE (Internet Key Exchange) for generating SA (Security Association) by dynamically exchanging algorithm and key used for encryption or message authentication for the IPsec tunnel (207) used when the packets used for communication between the MN and the CN are transmitted and received through the tunneling of the packets between the MN and the HA when the MN makes communication with the CN (106) through the HA. For generation of this SA, previous mutual setting between the MN and the HA is also possible as in the case of the SA used for the packets between the MN and the HA. The MN starts the RR (Return Routability) sequence (207) to (211) of Internet key exchange for calculating a Hash value included in the binding update registration (224) between the MN and the HA in the case where the packets from the CN (106) as the communication partner are received through the IPsec tunnel between the MN and the HA. The MN does not transmit the binding update registration to the CN not binding to this sequence and makes communication using the IPsec tunnel between the HA and the MN. Therefore, the RR sequence may also be used for checking whether the CN binds to the route optimization or not. (208) is HoTI (Home Test Init) for transmitting, via the HA, a home start cookie value or the like for calculation of the Hash value used for the binding update registration (224). (210) is CoTI (Care-of Test Init) for transmitting in direct, to the CN, the care-of start cookie value or the like for calculation of Hash value used for the binding update registration (224). The HoTI (208) is transmitted to the CN (106) via the IPsec tunnel (207) between the MN and the HA, while the CoTI is transmitted in direct to the CN without the HA. The CN receives the HoT (Home Test) (209) as the response to the HoTI from the CN via the IPsec tunnel between the MN and the HA. Meanwhile, the MN receives the CoT (Care-of Test) (211) as the response to the CoTI from the CN. When there is no error in both packets, it indicates that the CN (106) has the function binding to the route optimization. In this case, the MN (105) checks whether the encrypted communication by the IPsec with the CN (106) is possible or not. Only when the communication by the IPsec is possible, the route optimization is conducted. The MN (105) does not conduct binding update registration to the CN (106) when it has decided that the encrypted communication by the IPsec with the CN (106) is impossible. Accordingly, the packets between the CN and the MN pass the tunnel protected by the IPsec between the HA and the MN via the HA and therefore the packets between the MN and the CN are protected by the IPsec even in the moving destination of the MN. Therefore, when the RR sequence has completed successfully, the MN dynamically adds the encrypted communication with the CN to the SPD (Security Policy Database) (212). When the CN is added to the SPD of the MN, the MN (105) tries to transmit the binding update registration (226) to the CN (106) but the MN (105) drives the IKE for dynamically exchanging algorithm and key used for encryption or message authentication with the CN (106) and generates the SA (Security Association) (213) to (223) in order to check, because the CN (106) is added to the SPD, whether the encrypted communication is possible or not before transmission of the binding update registration. This IKE is conducted via the HA (101) through the IPsec tunnel (207) between the MN and the HA. The processes (213) to (218) are implemented in the main mode or aggressive mode in the sequence called the phase 1 (219) of the IKE. In the main mode, the phase 1 is completed and the ID information is protected using six messages, while in the aggressive mode, the phase 1 is completed with three messages but the ID information is not protected in a certain case. In the case where an IP address is used as the ID information and a preceding common secret key authentication system is used, the aggressive mode is employed. In the phase 1 (219) of the IKE, the ISAKMP SA is generated but it may be eliminated when the ISAKMP SA is already generated between the MN and the CN before moving of the MN. Both MN and CN set, through communication, the encryption algorithm, authentication algorithm, key, effective time of the IPsec SA or the like used for protection of packets between the MN and the CN with the phase 2 (223) of the IKE of (220) to (222) by making use of the ISAKMP SA generated. The MN sets (224), when the MN has succeeded in the IKE with the CN, the SA for communication with the CN and the CN sets the SA for MN (225). Next, the MN transmits the binding update registration (226) protected by the IPsec to the CN. The CN may return the response (227) for the binding update registration when the CN has received the binding update registration. Thereafter, the MN (105) and the CN (106) are capable of making direct communication without HA (101). Accordingly, when the MN moves to the network including a certain problem on the security such as tapping of communication contents or the like, it can dynamically change the setting of the IPsec and can realize safe communication with the CN which is not making communication with the IPsec in the timing that the MN (105) is accommodated within the home network.

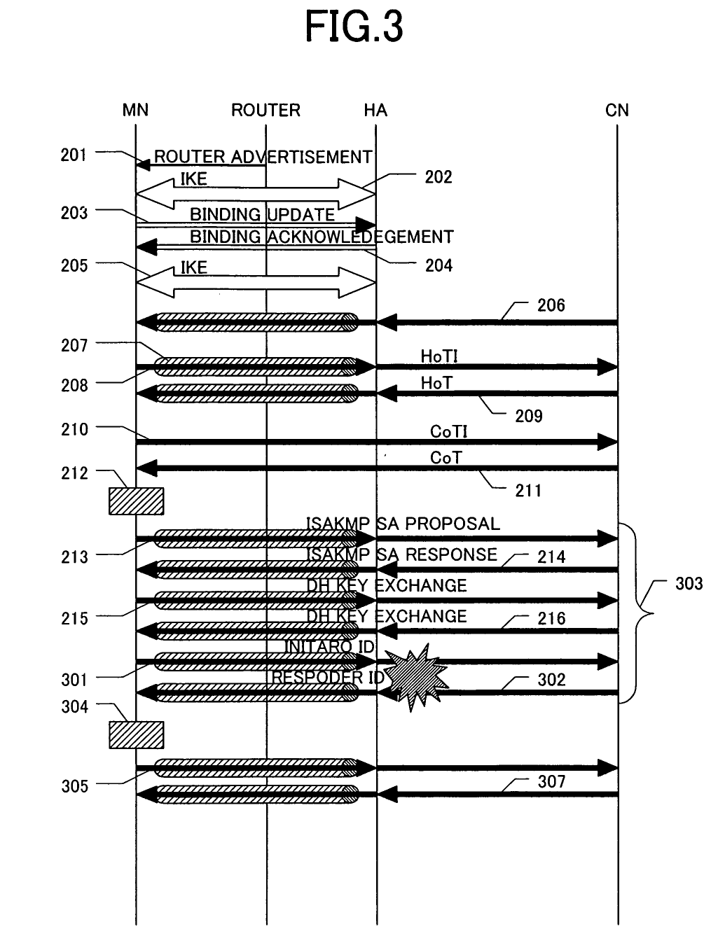

FIG. 3 illustrates operations when the MN moves like FIG. 2 and fails the IKE between the MN and the CN. After reception of the RA as in the case of FIG. 2 (201), the MN performs the IKE (202) with the HA to generate the SA and implement the binding update registration (203), (204). Moreover, MN also generates the SA for the IPsec tunnel between the MN and the HA with the IKE (205) Next, the MN executes the RR sequence ((208) to (211)), upon reception of the packets via the IPsec tunnel between the MN and the HA (206). When the RR sequence has completed successfully, the MN dynamically adds the encrypted communication with the CN to the SPD (Security Policy Database) (212). When the CN is added to the SPD of the MN, the MN drives the IKE for dynamically exchanging the algorithm and key used for the encryption or message authentication with the CN for the encrypted communication before transmission of the binding update registration and tries to generate the SA (Security Association) ((213) to (216), (301), (302)). This IKE is performed via the HA through the IPsec tunnel (207) between the MN and the HA. If setting of the SA fails between the MN and the CN because of a certain reason during the IKE ((301), (302)), the MN deletes the SPD regarding the CN added previously and conducts setting for impeding start of the RR sequence even when the packets from the CN are received via the IPsec tunnel (304). In the example of FIG. 3, the IKE has failed in the Phase 1 (303) of the IKE but the setting explained above is also true even for the fail in the phase 2 (223) of the IKE. Here, the MN suspends transmission of the binding update registration to the CN and thereafter makes communication with the CN through the IPsec tunnel (206) via the HA. In this case, since the route between the MN and the HA is protected by the IPsec tunnel, the safe communication is ensured even when the MN moves to the network including a certain problem on the security such as tapping of communication content by utilizing the IPsec tunnel via the HA for the communication between the MN and the CN.

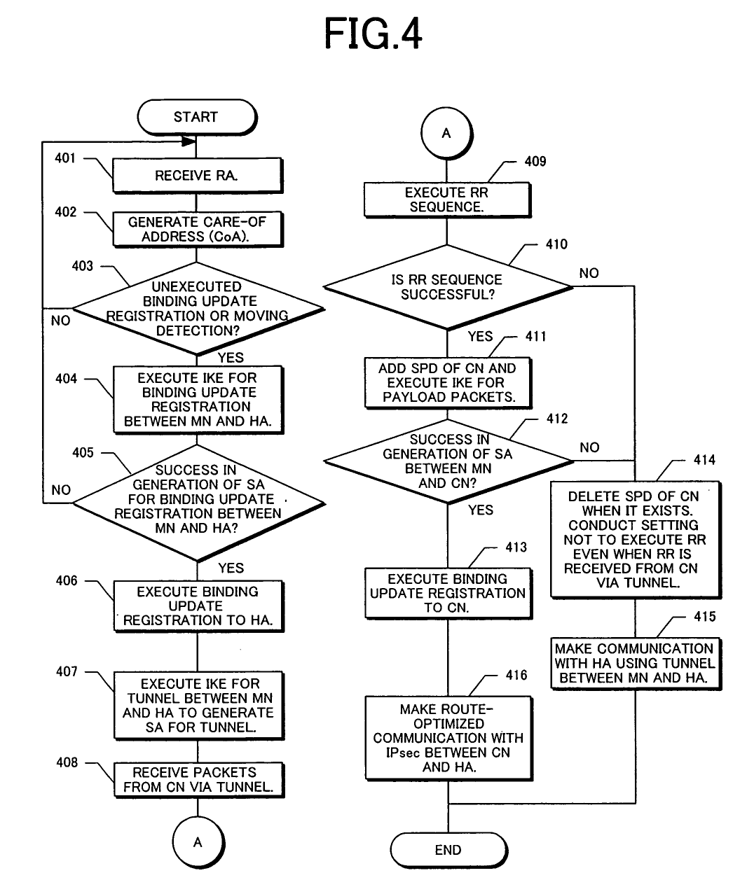

FIG. 4 is a flowchart illustrating operations of the MN in FIG. 2 and FIG. 3. The MN starts binding update registration to the HA, upon detection (403) of moving through generation (402) of a care-of address (CoA) after reception of the RA (401). (404) is the IKE for generating the SA to protect the packets used for the binding update registration with the HA. If generation of the SA fails, the MN repeats the processes from the beginning. (406) is the binding update registration for the HA from the MN. (407) is the IKE for the IPsec tunnel between the MN and the HA, which may be used for generation of the SA for the IPsec tunnel. The MN tries the route optimization when it has received the packets from the CN via the IPsec tunnel. The MN starts the RR sequence for the CN (409). When the RR sequence is set up successfully (410) enabling the route optimization, the MN executes the IKE for the CN through the IPsec tunnel with the HA before binding update registration to the CN (411). When the SA is generated between the MN and the CN after successful IKE (412), the MN performs the binding update registration to the CN (413) and thereafter makes the route-optimized communication between the MN and the CN with the IPsec (416). If the RR sequence fails in the process (410) and if generation of the SA fails between the MN and the CN, communication with the CN can be implemented through the IPsec tunnel via the HA. When the unwanted SPD exists for the CN, it is deleted and moreover setting is necessary to suspend start of the RR sequence even when the packets are received from the CN via the IPsec tunnel (414).

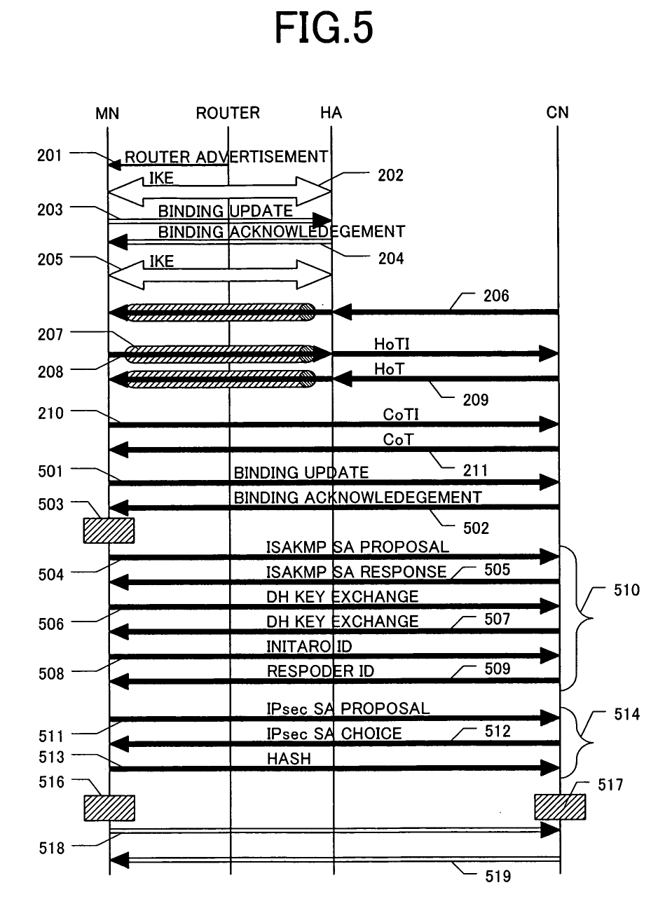

Next, operations for conducting the IKE between the MN and the CN after the binding update registration will be illustrated in FIG. 5 as the other embodiment. In FIG. 5, the operations similar to that in FIG. 2 are illustrated in the steps (201) to (211). (510) is binding update registration for the CN and the CN may return the response to the binding update registration (502). Upon success of the RR sequence or transmission (501) of the binding update registration, the CN is added to the SPD to protect the communication between the MN and the CN with the IPsec (503). Next, when the CN is added to the SPD, the MN drives, when there is no SA in the case where it is required to transmit the packages to the CN, the IKE for dynamically exchanging the algorithm and key for encryption or message authentication used for the communication between the MN and the CN and generates the SA (Security Association) (504) to (515). This IKE is conducted with route optimization. The steps (504) to (509) set up the sequence called the phase 1 (510) of the IKE and are executed in the main mode or aggressive mode. In the phase 1 of the IKE (510), the ISAKMP SA is generated but it may be eliminated when the ISAKMP SA is already generated between the MN and the CN. Both MN and CN utilizes the ISAKMP SA communicate with each other the encryption algorithm, authentication algorithm, key and effective time of the IPsec SA or the like used to protect the packets between the MN and the CN with the phase 2 (514) of the IKE of (511) to (513) and respectively set the results thereof (516), (517). Subsequently, both MN and CN execute the route-optimized communications with the IPsec (518), (519).

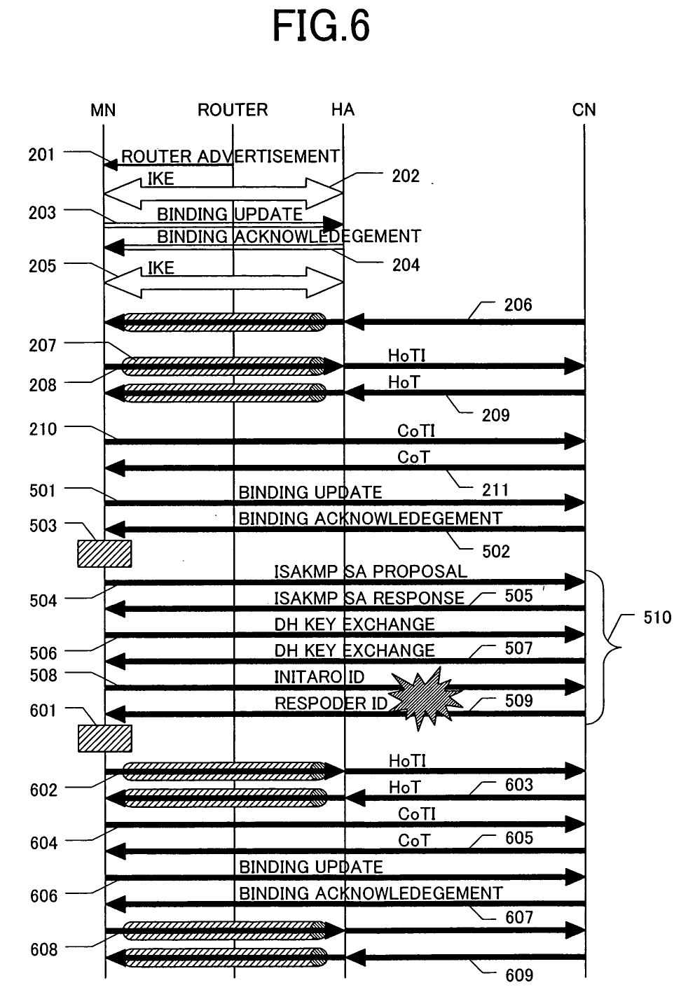

FIG. 6 illustrates operations when the IKE fails during implementation of the IKE between the MN and the CN after the binding update registration. Operations similar to that in FIG. 5 are indicated in the steps up to (201) to (211) and (501) to (503). If setting of the SA between the MN and the CN fails with a certain cause during the IKE (508), (509), the MN deletes the SPD regarding the CN added previously and executes the setting not to start the RR sequence even when the packets are received from the CN via the IPsec tunnel (601). In the example of FIG. 6, the IKE fails in the phase 1 (510) of the IKE. However, the operations explained above are also executed when the IKE fails in the phase 2 (514) of the IKE. Moreover, the packets from the CN are transmitted under this condition through the route optimization and therefore cancellation of the binding update registration to the CN is required. Accordingly, the MN executes again the RR sequence to the CN (602) to (605). In addition, the binding update registration of the CN for the MN is cancelled by transmitting, to the CN, the packets where the life time value is set to 0 among the binding update registration packets (606), (607). Thereafter, communications between the MN and the CN can be implemented safely, even when the MN moves to the network having a certain problem on the security such as tapping of communication content, by utilizing the tunnel between the MN and the CN protected by the IPsec.

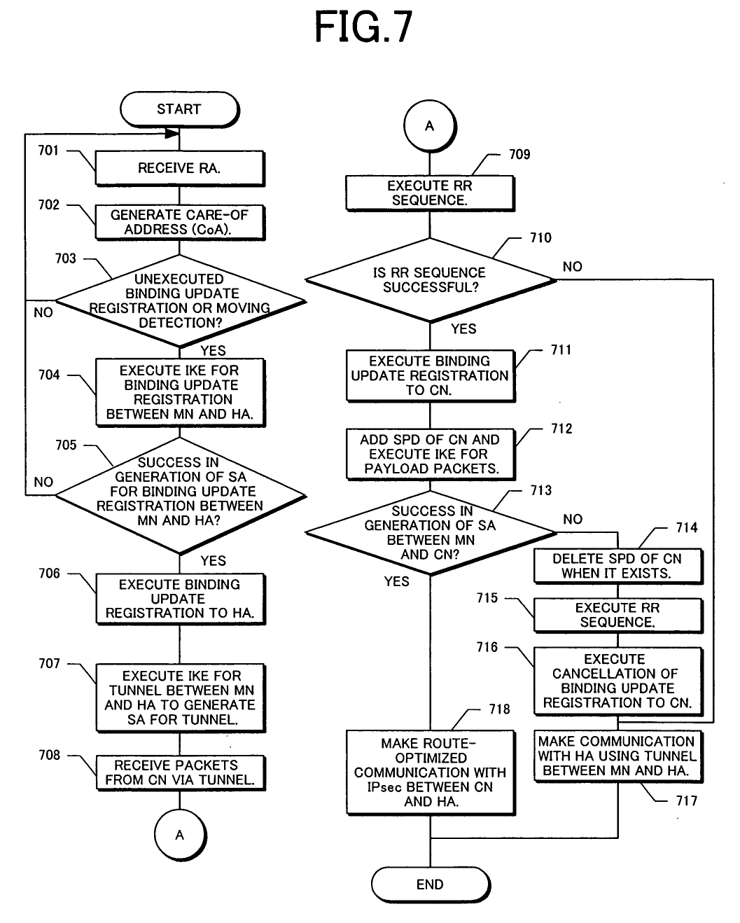

FIG. 7 is a flowchart illustrating operations of the MN in FIG. 5 and FIG. 6. The MN starts the binding update registration to the HA when moving of the MN is detected by generating (702) the care-of address (CoA) after reception (701) of the RA. (704) is the IKE for generating the SA for protecting the packets used for the binding update registration to the HA. When generation of the SA fails, the MN repeats the processes from the beginning. (706) is the binding update registration to the HA from the MN. (707) is the IKE for the IPsec tunnel between the MN and the HA, which may be used for generation of the SA for the IPsec tunnel. The MN tries, upon reception of the packets from the CN via the IPsec tunnel explained above, route optimization for the communication between the MN and the CN. The MN starts the RR sequence for the CN (709) and executes the binding update registration to the CN (711) because the route optimization is possible when the RR sequence is completed successfully. Moreover, the MN adds the CN to the SPD and executes the IKE for the CN when the packets to the CN are generated (712). When the IKE is completed successfully and the SA is generated between the MN and the CN (713), the route optimized communication with the IPsec is thereafter conducted between the MN and the CN (718). When the RR sequence fails in the step (710), the MN makes communication with the CN through the IPsec tunnel via the HA (717). Moreover, when the IKE between the MN and the CN fails and generation of the SA also fails (713), the MN deletes the SPD not required for the CN, when it exists, and also executes the setting not to start the RR sequence even when the MN receives the packets from the CN via the IPsec tunnel (714). Moreover, the MN executes the RR sequence for transmitting the binding update registration packets which is used for canceling the binding update registration to the CN (715), thereafter cancels the binding update registration to the CN by transmitting the packets in which the life time value of the binding update registration packets is set to 0 for the CN (716), and subsequently makes communication to the CN through the IPsec tunnel between the HA and MN via the HA (717).

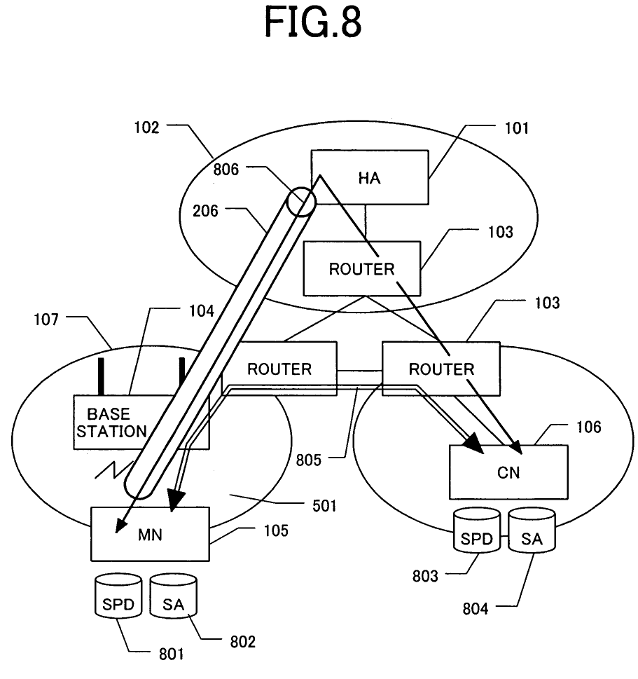

FIG. 8 illustrates a communication route (805) when the route optimization with the IPsec is conducted and a communication route (806) when the route optimization is not conducted. (801) indicates the SPD of the MN. Before the route optimization for the CN is executed, the SPD for binding update registration for the HA and the SPD for the IPsec tunnel are stored and when the route optimization is conducted, the SPD for the CN is dynamically added after the RR sequence for the CN or successful completion of the binding update registration to the CN. (802) is the SA and the SA for the CN is added after the IKE when the route optimization for the IPsec tunnel is conducted in addition to the SA for the binding update registration for the HA. (803) is the SPD of the CN, while (804) is the SA of the CN. For the route optimization, the SA for the MN is added after successful completion of the IKE of both MN and CN. If the IKE fails, such addition is not executed.

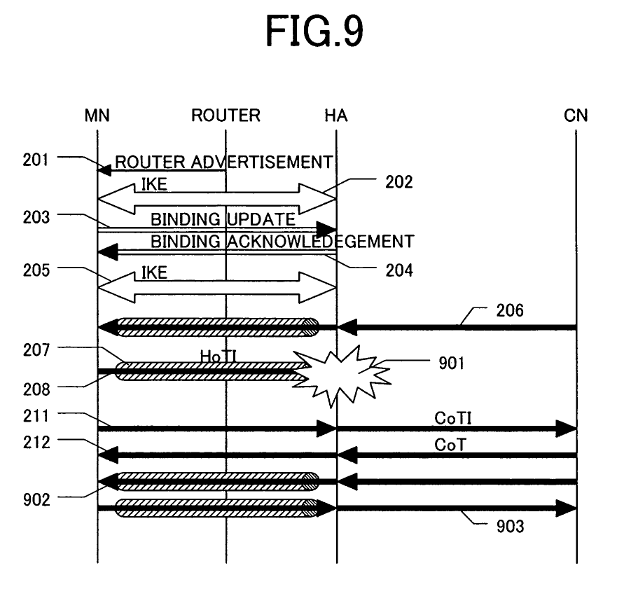

Operations in FIG. 9 are executed for deciding, in the HA, whether the route-optimized communication is enabled or not between the MN and the CN in accordance with the network of the moving destination to which the MN has moved or the network of the CN as the communication partner of the MN or the network to which the CN belongs. The HA has the function to set whether the route-optimized communication is possible or impossible in the network to which the MN has moved previously (designated with the address and the prefix length) and to store such setting into the memory of the HA. Similarly, the HA also has the function to set whether the route-optimized communication is possible or impossible in accordance with the network of the CN as the communication partner of the MN or the network to which the CN belongs (designated with the address and prefix length) and to store such setting into the memory of the HA. After reception of the RA (201), the MN executes the IKE (202) for the HA, generates the SA and executes the binding update registration (203), (204). Moreover, the MN generates the SA for the IPsec tunnel between the MN and the HA with the IKE (205). Next, the MN starts the RR sequence when it has received, from the CN, the packets via the IPsec tunnel (207) between the MN and the HA (206). When the CoTI (210) transmitted in direct to the CN from the MN arrives at the CN and the CN has the function to make the route-optimized communication with the MN, the CoT (Care-of Test) (211) is transmitted in direct to the MN from the CN as the response to the CoTI. The HoTI (208) is transmitted to the CN (106) via the IPsec tunnel (207) between the MN and the HA but the HA does not transfer, when the communication is disabled, the HoTI to the CN through the filtering by collating the condition, stored in the memory, for enabling or disable the route- optimized communication in accordance with the network of the moving destination of the MN with the condition, also stored in the memory, for enabling or disabling the route-optimized communication in accordance with the network to which the CN belongs (901). In this case, since the HoTI is not transmitted to the CN, the HoTI is not returned to the MN. Accordingly, the MN does not transmit the binding update registration to the CN and makes communications via the HA through the IPsec tunnel between the MN and the HA (902), (903).

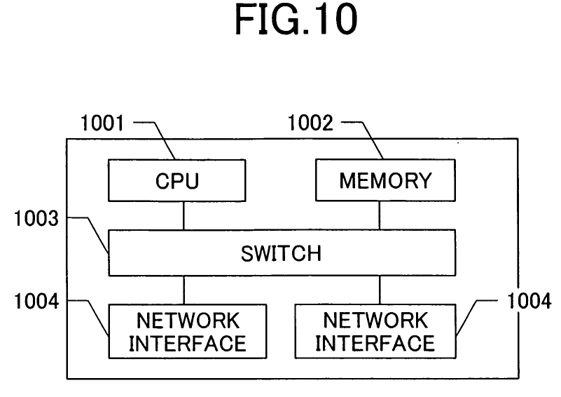

FIG. 10 is a diagram illustrating hardware configuration examples of the MN, CN, or HA. (1001) is a CPU, (1002) is a memory, and (1004) is a network interface. In some cases, a plurality of network interfaces are provided. (1003) is a system bus/switch. The CPU (1001), memory (1002), network interface (1004) are mutually connected through the system bus/switch (1003). The CPU (1001) operates under the control of the programs stored in the memory (1002). The MN has, within the memory (1002), the data of SA and SPD used for the IPsec communication with the HA or CN in order to protect the packets and the data of a binding update list indicating the CN making the route-optimized communication. The CN and HA also store, within the memory (1002) thereof, the data of SA and SPD used for making IPsec communication with the MN, and the information for binding cache of the home address and care-of address of the MN and the information for the network of the moving destination for enabling or disabling the route-optimized communication of the MN and the network of the CN.

The home agent apparatus and communication system of the present invention can be applied to a mobile node, a corresponding node, and a sensor having the wireless communication function which can provide safe communications without interventions of users even in the moving destination of the mobile node.

What is claimed is:

1. A home agent apparatus connected to a mobile node, a corresponding node of said mobile node and to a home network of said mobile node for management of a home address of said mobile node and a binding care-of address, wherein
communication between said mobile node and said corresponding node is relayed when the encrypted or authenticated communication cannot be made in direct between said mobile node and said corresponding node, and
communication between said mobile node and said corresponding node is not relayed when the encrypted or authenticated communication can be made in direct between said mobile node and said corresponding node.

2. A home agent apparatus connected to a mobile node, a corresponding node of said mobile node and to a home network of said mobile node for management of a home address of said mobile node and a binding care-of address, wherein
a memory storing the information for setting acknowledgment or non-acknowledgment of binding update registration is provided for at least any one of the network to which said mobile nodes are accommodated and the network to which said corresponding nodes are accommodated, and
a control unit is also provided for relaying binding update registration, when it is acknowledged, and for canceling said binding update registration, when it is not acknowledged, on the basis of said information stored in said memory, in the case where said binding update registration to said corresponding node from said mobile node or that to said mobile node from said corresponding node is received.

3. A communication system comprising a mobile node, a corresponding node of said mobile node, and a home agent apparatus connected to a home network of said mobile node for management of a home address of said mobile node and a binding care-of address, wherein
communication can be made between said mobile node and said corresponding node in direct without passing said home agent apparatus when said mobile node can make the encrypted or authenticated communication in direct with said corresponding node, and
communication can be made between said mobile node and said corresponding node via said home agent apparatus when said mobile node cannot make the encrypted or authenticated communication in direct with said corresponding node.

4. The communication systems according to claim 3, wherein said mobile node adds, when the encrypted or authenticated communication with said corresponding node is possible, said corresponding node to the security policy database prepared for the encrypted communication.

5. The communication system according to claim 3, wherein said mobile node deletes, when the encrypted or authenticated communication with said corresponding node is impossible, said corresponding node from the security policy database prepared for the encrypted communication.

6. The communication system according to claim 3, wherein said mobile node transmits a request to delete the binding update registration of said mobile node to said corresponding node when the encrypted or authenticated communication with said corresponding node is impossible.

7. The communication system according to claim 3, wherein said mobile node starts the Internet key exchange sequence after the binding update registration to said corresponding node when the encrypted or authenticated communication with said corresponding node is possible.

8. The communication system according to claim 3, wherein said corresponding node is a mobile node.

9. The communication system according to claim 3, wherein the corresponding node adds the mobile node to the security policy database prepared for the encrypted communication with said mobile node when the encrypted or authenticated communication with said corresponding node is possible.

10. The communication system according to claim 3, wherein said mobile node has the routing function.
